(19) United States
(12) Patent Application Publication
(10) Pub. No.: US 2026/0237313 A1
(43) Pub. Date: Aug. 13, 2026

(54) OPERATION EDUCATION SUPPORT DEVICE, OPERATION EDUCATION SUPPORT SYSTEM, METHOD, AND PROGRAM

(71) Applicant: NEC Corporation, Tokyo (JP)

(72) Inventors: Yumiko URASAWA, Tokyo (JP); Takahiro KAWAZU, Tokyo (JP)

(73) Assignee: NEC Corporation, Tokyo (JP)

(21) Appl. No.: 19/153,400

(22) PCT Filed: Jan. 15, 2024
(86) PCT No.: PCT/JP2024/000815

§ 371 Date: Aug. 4, 2025

(30) Foreign Application Priority Data
Feb. 14, 2023 (JP) 2023-020684

(51) Int. Cl. G09B 5/02; G06N 20/00

(52) U.S. Cl. CPC G09B 5/02; G06N 20/00

(57) ABSTRACT

The log collection means 71 collects logs generated in response to an operator's operations from a terminal where the operations are performed by the operator for task execution. The determination means 72 determines, for each collected log, whether the operator who was operating when the log was generated is an excellent operator or a non-excellent operator, using a first model for determining whether the operator who was operating when the log was generated is an excellent operator or a non-excellent operator. The video generation means 73 generates an operation procedure video in response to the log of the operator determined as an excellent operator, using a second model for generating the operation procedure video in response to the log. The delivery means 74 delivers the operation procedure video to an education terminal used by an operator to learn an operation procedure for task execution.

### TECHNICAL FIELD

The present invention relates to an operation education support device, an operation education support system, an operation education support method, and an operation education support program.

### BACKGROUND ART

In general, an operator operate a terminal to perform various tasks. Examples of such tasks include, for example, an operational task of an artificial satellite, determining work shifts of employees at a retail store (hereinafter referred to as “work shift determination task”), and so on. However, tasks are not limited to these examples.

There is an operation procedure for operating a terminal for performing a task. An excellent operator can perform an operation accurately and quickly. On the other hand, a less excellent operator and a new operator are generally unable to perform an operation accurately and quickly.

PTL 1 describes a driving training simulator for driving training. Also, PTL 2 describes an evaluation device for evaluating a signal operation in traffic.

### CITATION LIST

### Patent Literature

PTL 1: Japanese Patent Application Laid-Open No. 2020-201304

PTL 2: Japanese Patent Application Laid-Open No. 2014-164706

### SUMMARY OF INVENTION

### Technical Problem

When an operation procedure for performing a task is complicated, it is difficult for a new operator to learn the operation procedure, and it takes time to educate a new operator. Especially in departments where operators change frequently, it takes more time to educate new operators.

In addition, when an operator is a foreigner who uses a language different from the one displayed on the terminal, it also takes time to educate the foreigner.

Therefore, the purpose of the present invention is to provide an operation education support device, an operation education support system, an operation education support method, and an operation education support program that enables efficient education of an operation procedure of a task.

### Solution to Problem

An operation education support device according to the present invention includes: log collection means for collecting logs generated in response to an operator's operations from a terminal where the operations are performed by the operator for task execution; determination means for determining, for each collected log, whether the operator who was operating when the log was generated is an excellent operator or a non-excellent operator, using a first model for determining whether the operator who was operating when the log was generated is an excellent operator or a non-excellent operator; video generation means for generating an operation procedure video in response to the log of the operator determined as an excellent operator, using a second model for generating the operation procedure video in response to the log; and delivery means for delivering the operation procedure video to an education terminal used by an operator to learn an operation procedure for task execution.

An operation education support system according to the present invention includes: an education terminal; and the operation education support device described above; wherein the education terminal comprises: display control means for displaying the operation procedure video delivered by the operation education support device on a display device.

An operation education support method according to the present invention is characterized in that, a computer, collects logs generated in response to an operator's operations from a terminal where the operations are performed by the operator for task execution; determines, for each collected log, whether the operator who was operating when the log was generated is an excellent operator or a non-excellent operator, using a first model for determining whether the operator who was operating when the log was generated is an excellent operator or a non-excellent operator; generates an operation procedure video in response to the log of the operator determined as an excellent operator, using a second model for generating the operation procedure video in response to the log; and delivers the operation procedure video to an education terminal used by an operator to learn an operation procedure for task execution.

An operation education support program according to the present invention causes a computer to execute: a log collection process of collecting logs generated in response to an operator's operations from a terminal where the operations are performed by the operator for task execution; a determination process of determining, for each collected log, whether the operator who was operating when the log was generated is an excellent operator or a non-excellent operator, using a first model for determining whether the operator who was operating when the log was generated is an excellent operator or a non-excellent operator; a video generation process of generating an operation procedure video in response to the log of the operator determined as an excellent operator, using a second model for generating the operation procedure video in response to the log; and a delivery process of delivering the operation procedure video to an education terminal used by an operator to learn an operation procedure for task execution.

### Advantageous Effects of Invention

The present invention enables efficient education of an operation procedure of a task.

### BRIEF DESCRIPTION OF DRAWING

FIG. 1 It depicts a schematic diagram showing an example of an operation education support system of the example embodiment of the present invention.

FIG. 2 It depicts a block diagram showing a configuration example of an operation education support device of the example embodiment of the present invention.

FIG. 3 It depicts a block diagram showing a configuration example of an education terminal.

FIG. 4 It depicts a flowchart showing an example of the processing flow when the operation education support device generates an operation procedure video.

FIG. 5 It depicts a flowchart showing an example of the processing flow when the operation education support device generates an operation procedure video.

FIG. 6 It depicts a flowchart showing an example of the processing flow when the operation education support device delivers the operation procedure video to the education terminal and the education terminal displays the operation procedure video.

FIG. 7 It depicts a block diagram showing a configuration example of an operation education support device in a case where an external device generates the first model and the second model.

FIG. 8 It depicts a schematic block diagram showing an example of a computer configuration of the operation education support device of the present invention.

FIG. 9 It depicts a block diagram showing an overview of the operation education support device of the present invention.

### DESCRIPTION OF EMBODIMENTS

An example embodiment of the present invention is described below with reference to the drawings.

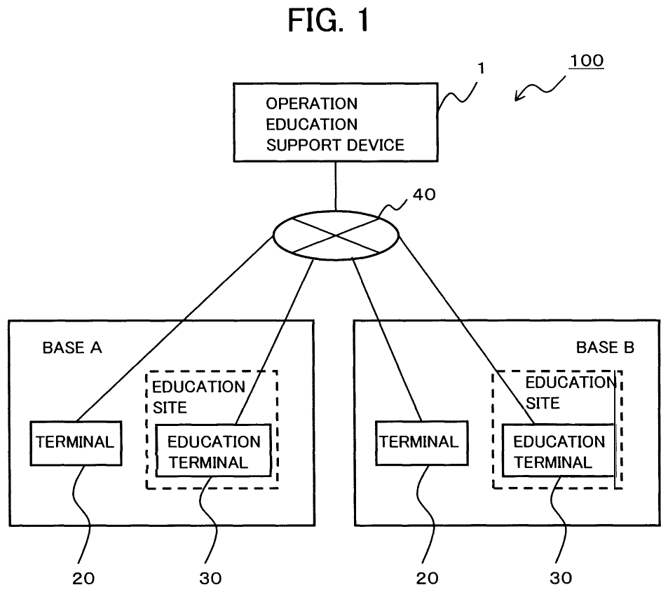

FIG. 1 is a schematic diagram showing an example of an operation education support system of the example embodiment of the present invention.

FIG. 1 shows an example of a case in which there are two bases where tasks are performed and education is provided to newcomers, but the number of bases may be one, three, or more. In the present example embodiment, the case in which a terminal 20 where operations for task execution are performed and an education terminal 30 for operators to learn an operation procedure to perform a task are provided at each base is also shown as an example. The case in which the education terminal 30 is installed at an educational site at each base is also shown as an example. However, the terminal 20 and the education terminal 30 may be the same terminal.

The operation education support system 100 of the present example embodiment includes an operation education support device 1, the terminal 20, and the education terminal 30. The operation education support device 1 is communicatively connected to each terminal 20 and each education terminal 30 via a communication network 40. The number of the terminals 20 and the number of the education terminals 30 are not particularly limited.

The terminal 20 is a terminal at which an operator performs operations for task execution. When the operator performs an operation from the start to the end of a task, terminal 20 generates a log corresponding to the operator's operation performed from the start to the end of the task and stores the log. In other words, one log is generated for one task execution.

Examples of tasks include, but are not limited to, an operational task of an artificial satellite and a work shift determination task, as described above.

One operator is not necessarily assigned to one terminal 20, and multiple operators may use one terminal 20 in rotation. However, it is assumed that the operator is not be replaced between the start and the end of a task.

An operator who can perform an operation accurately and quickly is hereinafter referred to as “an excellent operator” and one who is not an excellent operator is referred to as “a non-excellent operator”.

The operation education support device 1 collects logs generated in response to an operator's operation from each terminal 20. For each collected log, the operation education support device 1 determines whether the operator who was operating when the log was generated is an excellent operator or a non-excellent operator. The operation education support device 1 generates an operation procedure video according to the log of the operator determined to an excellent operator, and stores the operation procedure video. Upon request from an education terminal 30, the operation procedure video is distributed to the education terminal 30.

The education terminal 30 is a terminal used by an operator (especially, a non-excellent operator such as a newcomer) to learn an operation procedure for task execution. The education terminal 30 requests the operation procedure video to the operation education support device 1 and receives the operation procedure video delivered from the operation education support device 1. The education terminal 30 then displays the operation procedure video on its display device. The non-excellent operator using the education terminal 30 learns the operation procedure by, for example, viewing the displayed operation procedure video or competing against the operation procedure video in a precise and quick operation competition.

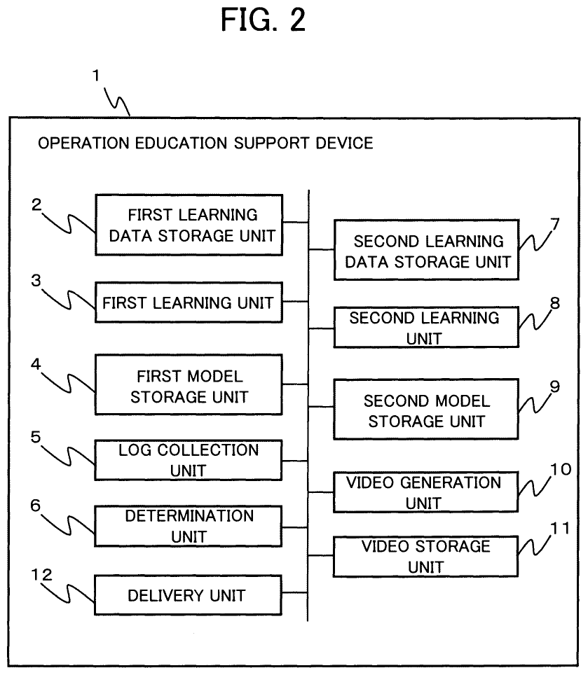

FIG. 2 is a block diagram showing a configuration example of the operation education support device 1 of the example embodiment of the present invention. The operation education support device 1 includes a first learning data storage unit 2, a first learning unit 3, a first model storage unit 4, a log collection unit 5, a determination unit 6, a second learning data storage unit 7, a second learning unit 8, a second model storage unit 9, a video generation unit 10, a video storage unit 11, and a delivery unit 12.

The first learning data storage unit 2 is a storage device that stores a set of pairs of a log generated in response to an operation determined to be excellent and a label of an excellent operator, and a set of pairs of a log generated in response to an operation determined to be non-excellent and a label of a non-excellent operator. Initially, for example, the administrator of the operation education support device 1 prepares the above data and stores the above data in the first learning data storage unit 2. Hereafter, the set of pairs of a log generated in response to an operation determined to be excellent and a label of an excellent operator, and the set of pairs of a log generated in response to an operation determined to be non-excellent and a label of a non-excellent operator are denoted as the learning data for generating the first model. The first model is a model for determining, given a log, whether the operator who was performing the operation when the log was generated was an excellent operator or a non-excellent operator.

The first learning unit 3 generates the first model by machine learning using the learning data for generating the first model stored in the first learning data storage unit 2. The first learning unit 3 stores the first model in the first model storage unit 4.

The first model storage unit 4 is a storage device that stores the first model.

As described below, new data is added to the learning data for generating the first model. The first learning unit 3 re-generates the first model by machine learning using the learning data for generating the first model to which the new data has been added, and overwrites the first model and stores it in the first model storage unit 4. As a result, the first model stored in the first model storage unit 4 is updated.

The log collection unit 5 collects, via the communication network 40 (see FIG. 1), logs generated in response to the operator's operations from each of the terminals where the operations are performed by the operator for task execution. The log collection unit 5 collects multiple logs.

The determination unit 6 determines, for each collected log, whether the operator who was operating when the log was generated is an excellent operator or a non-excellent operator, using the first model stored in the first model storage unit 4. For each log, the determination unit 6 determines, by applying the log to the first model, whether the operator who was operating when the log was generated is an excellent operator or a non-excellent operator. The determination unit 6 can be said to be an AI (Artificial Intelligence) that, given a log, determines whether the operator who was operating when the log was generated is an excellent operator or a non-excellent operator.

After the above determination, the determination unit 6 adds the pair of the log used for the determination and the determination result (a label of an excellent operator or a non-excellent operator) as the new data to the learning data for generating the first model stored in the first learning data storage unit 2. As described above, the first learning unit 3 re-generates the first model by machine learning using the learning data for generating the first model to which the new data has been added, and overwrites the first model and stores it in the first model storage unit 4. Therefore, the longer the operation of the operation education support device 1 continues, the more data volume of the learning data for generating the first model increases. As a result, the determination accuracy of the first model increases.

The first learning unit 3 may periodically (e.g., every month) re-generate the first model by machine learning using the learning data for generating the first model at that time. Alternatively, the first learning unit 3 may re-generate the first model by machine learning using the learning data for generating the first model at that time when a command to re-generate the first model is input by the administrator of the operation education support device 1.

The second learning data storage unit 7 is a storage device that stores a set of pairs of a log and an operation procedure video that represents the operation procedure when the log was generated. For example, the administrator of the operation education support device 1 prepares the above data and stores the above data in the second learning data storage unit 7 in advance. Hereafter, the set of pairs of a log and an operation procedure video representing the operation procedure when the log was generated is denoted as the learning data for generating the second model. The second model is a model for generating an operation procedure video according to the log when the log is given. The logs included in the learning data for generating the second model are not limited to those generated in response to the operations of the excellent operator. The logs included in the learning data for generating the second model include logs generated in response to the operations of the excellent operator and logs generated in response to the operations of the non-excellent operator.

The second learning unit 8 generates the second model by machine learning using the learning data for generating the second model stored in the second learning data storage unit 7. The second learning unit 8 stores the second model in the second model storage unit 9.

The second model storage unit 9 is a storage device that stores the second model. The second learning unit 8 generates the second model by machine learning in advance before the operation of the operation education support device 1 starts, and stores the second model in the second model storage unit 9. No new data is added to the learning data for generating the second model, and the second model is not updated.

The video generation unit 10 generates an operation procedure video according to the log of the operator determined as an excellent operator using the second model stored in the second model storage unit 9. The video generation unit 10 generates the operation procedure video in response to the log of the operator determined as an excellent operator by applying the log to the second model. The video generation unit 10 can be said to be an AI that, given a log, generates an operation procedure video according to the log.

The log collection unit 5 collects multiple logs, and the determination unit 6 determines for each log whether the operator who was operating when the log was generated is an excellent operator or a non-excellent operator. Therefore, it is possible that there may be multiple logs of an operator who is determined to be an excellent operator. In this case, the determination unit 6 selects one log of the most excellent operator among the logs of the operators determined as an excellent operator. Specifically, the determination unit 6 selects one log with the shortest time from the start of operation to the end of operation from among multiple logs corresponding to the logs of the operators determined as an excellent operator. It can be said that the log of the operator determined to be an excellent operator is a log reflecting an accurate operation procedure, and the determination unit 6 selects one log with the shortest time from the start of operation to the end of operation (i.e., a log corresponding to the quickest operation) from among such a plurality of logs.

The video generation unit 10 generates one operation procedure video by applying one log selected as described above to the second model.

When there is only one log of an operator who is determined to be an excellent operator, the video generation unit 10 generates one operation procedure video by applying that one log to the second model.

The video generation unit 10 stores the one generated operation procedure video in the video storage unit 11.

The video storage unit 11 is a storage device that stores the operation procedure video.

The delivery unit 12 delivers the operation procedure video stored in the video storage unit 11 to the education terminal 30 (a terminal used by an operator to learn an operation procedure for task execution) upon request from the education terminal 30. The education terminal 30 displays the operation procedure video delivered from the delivery unit 12 of the operation education support device 1 on its display device.

The log collection unit 5 and the delivery unit 12 are realized, for example, by a CPU (Central Processing Unit) of a computer operating according to an operation education support program and a communication interface of the computer. In this case, the CPU may read the operation education support program from a program storage medium such as a program storage device of the computer, and operate as the log collection unit 5 and the delivery unit 12 according to the program using the communication interface.

The first learning unit 3, the determination unit 6, the second learning unit 8, and the video generation unit 10 are realized, for example, by the CPU of the computer operating according to the operation education support program. In this case, the CPU may read the operation education support program from a program storage medium such as a program storage device of the computer as described above, and operate as the first learning unit 3, the determination unit 6, the second learning unit 8, and the video generation unit 10 according to the program.

The first learning data storage unit 2, the first model storage unit 4, the second learning data storage unit 7, the second model storage unit 9, and the video storage unit 11 are realized by a storage device provided by the computer.

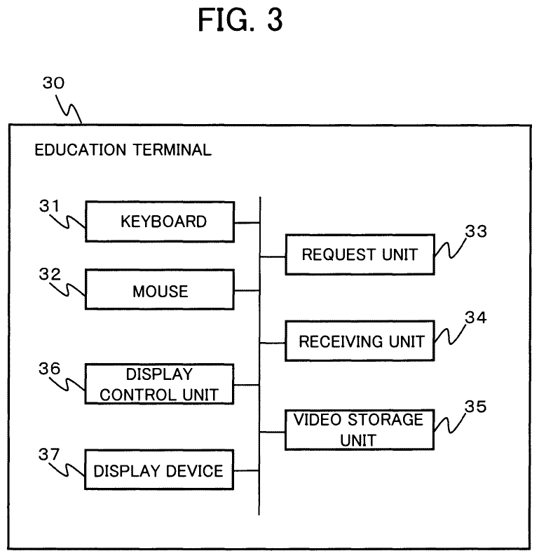

FIG. 3 is a block diagram showing a configuration example of the education terminal 30. The education terminal 30 illustrated in FIG. 3 includes a keyboard 31, a mouse 32, a request unit 33, a receiving unit 34, a video storage unit 35, a display control unit 36, and a display device 37.

The keyboard 31 and the mouse 32 are operating devices used by the operator to perform operations. The education terminal 30 may include operating devices other than the keyboard 31 and the mouse 32.

The request unit 33 sends a delivery request for the operation procedure video to the operation education support device 1. The delivery unit 12 of the operation education support device 1 delivers the operation procedure video to the education terminal 30 in response to the delivery request.

The receiving unit 34 receives the operation procedure video delivered by the operation education support device 1. The receiving unit 34 then stores the operation procedure video in the video storage unit 35.

The video storage unit 35 is a storage device that stores the operation procedure video delivered by the operation education support device 1.

The display control unit 36 displays the operation procedure video stored in the video storage unit 35 on the display device 37. For example, there are two display modes in which the display control unit 36 displays the operation procedure video on the display device 37, as shown below.

### [Display Mode 1]

The display control unit 36 simply displays the operation procedure video on the display device 37. In this case, the operator using the education terminal 30 (especially, a non-excellent operator such as a newcomer) learns the operation procedure for task execution by viewing the displayed operation procedure video.

### [Display Mode 2]

The display control unit 36 displays an image in accordance with the operation of an operator of the education terminal 30 (especially, a non-excellent operator such as a newcomer) side-by-side with the operation procedure video on the display device 37. The image in accordance with the operation of the operator of the education terminal 30 is the image in accordance with the operation of the operator simulating the task execution. In this case, the operator of the education terminal 30 learns the operation procedure for task execution by competing against the operation procedure video in a precise and quick operation competition.

The request unit 33 and the receiving unit 34 are realized, for example, by a CPU of a computer operating according to a program for an education terminal and a communication interface of the computer. In this case, the CPU may read the program for the education terminal from a program storage medium such as a program storage device of the computer, and operate as the request unit 33 and the receiving unit 34 according to the program using the communication interface.

The display control unit 36 is realized, for example, by the CPU of the computer operating in accordance with the program for the education terminal. In this case, the CPU may read the program for the education terminal from a program storage medium such as a program storage device of the computer as described above, and operate as the display control unit 36 according to the program.

The video storage unit 35 is realized by a storage device provided by the computer.

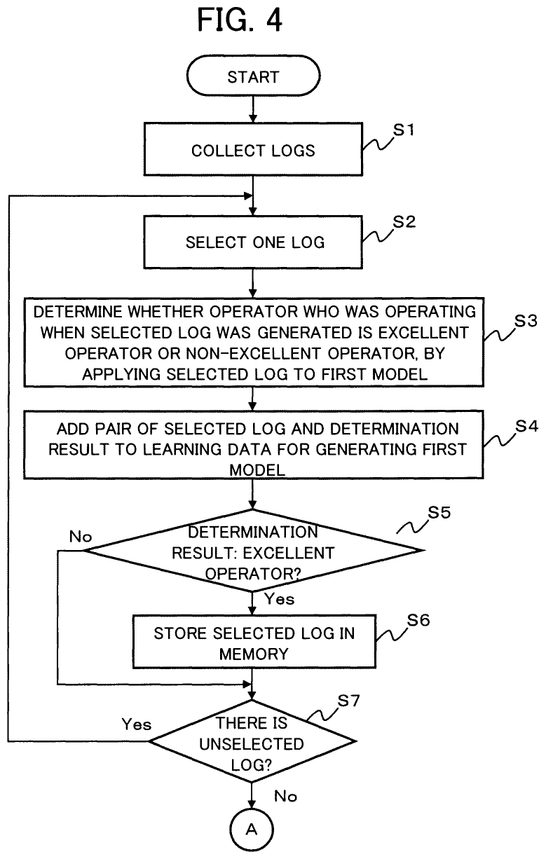

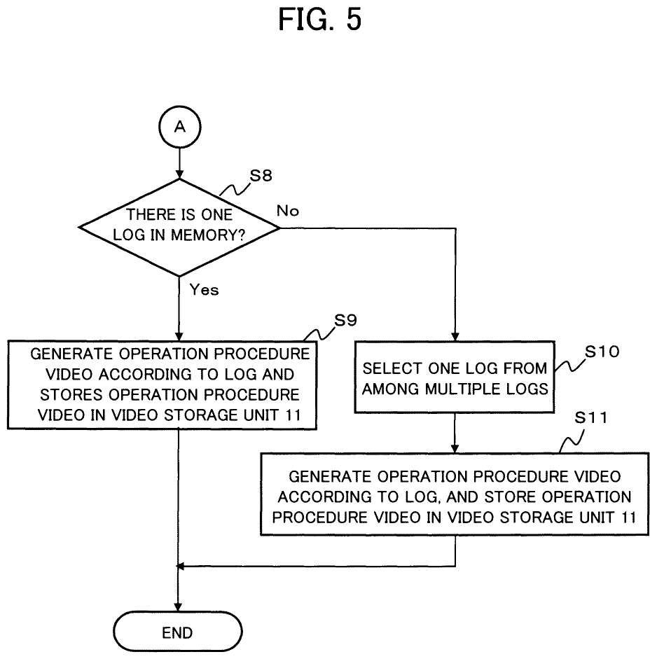

Next, the processing flow of the example embodiment of the present invention is described. FIG. 4 and FIG. 5 show a flowchart showing an example of the processing flow when the operation education support device 1 generates an operation procedure video. Here, it is assumed that the first model has already been generated and stored in the first model storage unit 4, and that the second model has already been generated and stored in the second model storage unit 9. The matters already explained are omitted as appropriate.

When the operation education support device 1 generates an operation procedure video, first, the log collection unit 5 collects logs from each terminal 20 (see FIG. 1) (step S1). In step S1, the log collection unit 5 collects multiple logs.

Next, the determination unit 6 selects one log from the multiple logs collected in step S1 (step S2). In step S2, the determination unit 6 selects a log that has not yet been selected. The log selected in step S2 is hereinafter referred to as the selected log.

Next, by applying the selected log to the first model, the determination unit 6 determines whether the operator who was operating when the selected log was generated is an excellent operator or a non-excellent operator (step S3).

Next, the determination unit 6 adds the pair of the selected log and the determination result (the label of an excellent operator or the label of a non-excellent operator) to the learning data for generating the first model (step S4).

When the determination result in step S3 is “an excellent operator” (Yes in step S5), the determination unit 6 stores the selected log in the memory of the operation education support device 1 (not shown in FIG. 2) (step S6). After step S6, the process moves to step S7. The log stored in the memory is the log of the operator who is determined to be an excellent operator.

When the determination result in step S3 is “a non-excellent operator” (No in step S5), the process moves to step S7 without performing step S6.

In step S7, the determination unit 6 determines whether there is a log that has not been selected in step S2 among the multiple logs collected in step S1.

When there is a log that has not been selected in step S2 (step S7 Yes), the determination unit 6 repeats the operation from step S2 onward.

When all the collected logs have been selected (No in step S7), the process moves to step S8 (see FIG. 5).

In step S8, the determination unit 6 determines whether there is one log stored in memory or two or more logs.

When there is one log stored in memory (step S8 Yes), the video generation unit 10 generates an operation procedure video according to the log and stores the operation procedure video in the video storage unit 11 (step S9). The process ends at step S9.

When there are two or more logs stored in the memory (No in step S8), the determination unit 6 selects one log from the multiple logs stored in the memory (step S10). Specifically, the determination unit 6 selects one log that has the shortest time from the start of operation to the end of operation from among the multiple logs.

Next to step S10, the video generation unit 10 generates an operation procedure video according to the log selected in step S10, and stores the operation procedure video in the video storage unit 11 (step S11). The process ends at step S11.

In the above process, new data is added to the learning data for generating the first model in step S4. As already described, the first learning unit 3 re-generates the first model by machine learning using the learning data for generating the first model to which the new data has been added, and overwrites the first model and stores it in the first model storage unit 4. The first learning unit 3 may periodically re-generate the first model by machine learning using the learning data for generating the first model at that time. Alternatively, the first learning unit 3 may re-generate the first model by machine learning using the learning data for generating the first model at that time when a command to re-generate the first model is input by the administrator of the operation education support device 1. When the operation education support device 1 overwrites and stores the new first model in the first model storage unit 4, the operation after step S1 may be performed again.

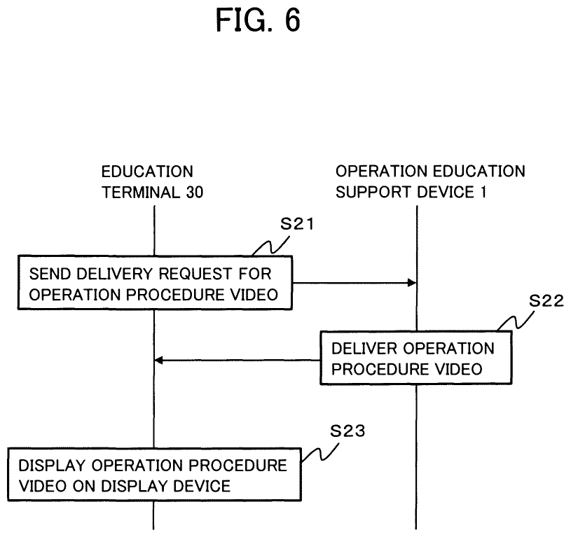

FIG. 6 is a flowchart showing an example of the processing flow when the operation education support device 1 delivers the operation procedure video to the education terminal 30 and the education terminal 30 displays the operation procedure video. The matters already explained are omitted as appropriate.

When the request unit 33 of the education terminal 30 receives a transmission command for a delivery request from the operator of the terminal 30, the request unit 33 sends a delivery request for the operation procedure video to the operation education support device 1 (step S21).

The delivery unit 12 of the operation education support device 1 receives the delivery request. The delivery unit 12 delivers the operation procedure video stored in the video storage unit 11 to the education terminal 30 in response to the delivery request (step S22).

The receiving unit 34 of the education terminal 30 receives the operation procedure video delivered in step S22 and stores the operation procedure video in the video storage unit 35.

The display control unit 36 then displays the operation procedure video on the display device 37 (step S23).

In step S23, the display control unit 36 may simply display the operation procedure video on the display device 37. In this case, the operator of the education terminal 30 learns the operation procedure for task execution by viewing the displayed operation procedure video.

In step S23, the display control unit 36 may display the image in accordance with the operation of the operator of the education terminal 30 side-by-side with the operation procedure video on the display device 37. In this case, the operator of the education terminal 30 learns the operation procedure for task execution by competing against the operation procedure video in a precise and quick operation competition.

According to the present example embodiment, the determination unit 6 determines for each log whether the operator who was operating when the log was generated is an excellent operator or a non-excellent operator. The video generation unit 10 generates the operation procedure video according to the log of the operator determined as an excellent operator. This operation procedure video can be said to represent the operation procedure of the excellent operator, and therefore, it can be said to show accurate and quick operation for task execution. The delivery unit 12 delivers the operation procedure video to the education terminal 30, and the display control unit 36 of the education terminal 30 displays the operation procedure video on the display device 37. Thus, the operator of the education terminal 30 can learn the operation procedure for task execution by viewing the precise and quick operation for task execution. Therefore, according to the present embodiment, education of an operation procedure of a task can be performed efficiently.

In particular, when the display control unit 36 displays an image in accordance with the operation of the operator of the education terminal 30 side by side with the operation procedure video on the display device 37, the operator of the education terminal 30 can compete for precise and quick operation against the operation procedure video. By competing in this way, the operator can more efficiently learn the operation procedure for task execution.

As described above, according to the present example embodiment, education of an operation procedure of a task can be performed efficiently. Therefore, it is not necessary to spend time for educating a newcomer on the operation procedure for task execution. In addition, even in departments where operators change frequently, it is not necessary to spend time on educating newcomers.

Even when the operator is a foreigner who uses a language different from the displayed language, the foreigner views the video showing accurate and quick operation for task execution (operation procedure video). Therefore, even when the foreigner does not understand the displayed language, the foreigner can efficiently learn the operation procedure for task execution.

In the present example embodiment, the determination unit 6 adds new data to the learning data for generating the first model. Then, the first learning unit 3 re-generates the first model by machine learning using the learning data for generating the first model to which the new data has been added. Thus, the longer the operation of the operation education support device 1 continues, the more data volume of the learning data for generating the first model increases, and the more accurate the determination accuracy of the first model can be improved.

Next, a variation of the above example embodiment is described.

The above example embodiment shows a case in which the first model is updated by the determination unit 6 adding new data to the learning data for generating the first model, the first learning unit 3 re-generating the first model, and overwriting and storing that first model in the first model storage unit 4. Such updating of the first model may not be performed. In this case, the determination unit 6 does not need to add new data to the learning data for generating the first model. In other words, the process of step S4 shown in FIG. 4 may be omitted. Moreover, the first learning unit 3 may not have to re-generate the first model.

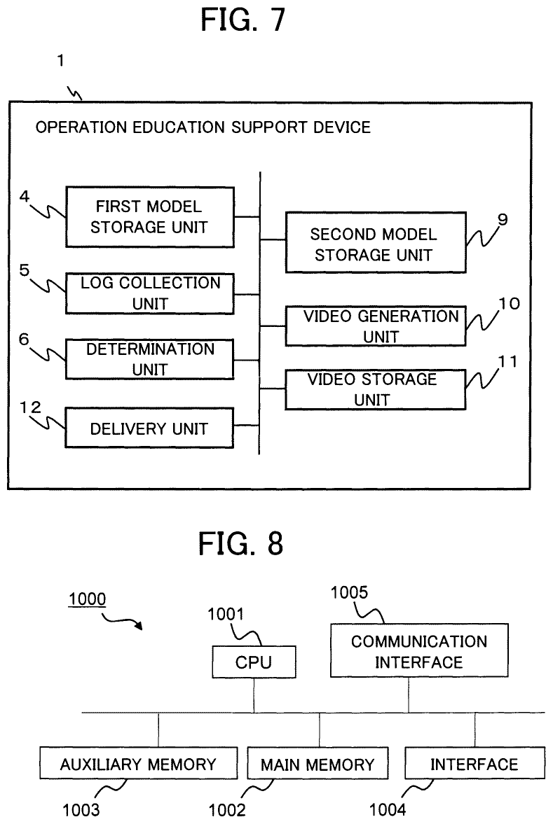

The first model and the second model may also be generated by a device external to the operation education support device 1 (not shown). FIG. 7 is a block diagram showing a configuration example of an operation education support device 1 in a case where the external device generates the first model and the second model. Components similar to those shown in FIG. 2 are marked with the same signs as those shown in FIG. 2.

In this case, the operation education support device 1 includes a first model storage unit 4, a log collection unit 5, a determination unit 6, a second model storage unit 9, a video generation unit 10, a video storage unit 11, and a delivery unit 12. The first learning data storage unit 2, the first learning unit 3, the second learning data storage unit 7 and the second learning unit 8 shown in FIG. 2 may not be provided.

The first model storage unit 4 in FIG. 7 stores the first model generated by the external device. The second model storage unit 9 in FIG. 7 stores the second model generated by the external device. For example, the administrator of the operation education support device 1 may store the first model generated by the external device in the first model storage unit 4 and the second model generated by the external device in the second model storage unit 9. In this case, the determination unit 6 does not need to add new data to the learning data for generating the first model. In other words, the process of step S4 shown in FIG. 4 may be omitted. Moreover, the first learning unit 3 may not have to re-generate the first model. Other operations are the same as in the above example embodiment.

The display control unit 36 (see FIG. 3) may also adjust the playback speed of the operation procedure video according to the operator's instruction when the operation procedure video is displayed on the display device 37.

For example, at the normal playback speed, the displayed operation may be moving too fast for the operator to grasp the operation procedure. In such a case, the display control unit 36 may slow down the playback speed of the operation procedure video according to the operator's instruction.

The display control unit 36 may also increase the playback speed of the operation procedure video according to the operator's instruction. For example, when the operator is competing against the operation procedure video in a precise and quick operation, the display control unit 36 may speed up the playback speed of the operation procedure video according to the operator's instruction. In this case, the operator can become accustomed to the faster operation and can perform the operation more quickly.

FIG. 8 is a schematic block diagram showing an example of a computer configuration of the operation education support device 1 of the present invention. The computer 1000, for example, includes a CPU 1001, main memory 1002, auxiliary memory 1003, interface 1004, and communication interface 1005.

The operation education support device 1 of the example embodiment of the present invention is realized by a computer 1000. The operation of the operation education support device 1 is stored in the auxiliary memory 1003 in the form of a program (an operation education support program). The CPU 1001 reads the program from the auxiliary memory 1003, expands the program into the main memory 1002, and executes the processes described in the above example embodiment and variations thereof according to the program.

The auxiliary memory 1003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 1004. When the program is delivered to the computer 1000 through a communication line, the computer 1000 receiving the delivery may expand the program into the main memory 1002 and execute the processes described in the above example embodiments and variations thereof according to the program.

Some or all of the components may be realized by general-purpose or dedicated circuits (circuitry), processor, or a combination of these. These may comprise a single chip or multiple chips connected via a bus. Some or all of each component may be realized by a combination of the above-mentioned circuitry, etc. and a program.

When some or all of each component are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

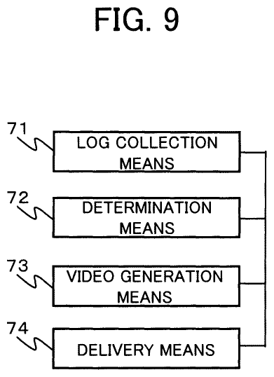

The following is an overview of the present invention. FIG. 9 is a block diagram showing an overview of the operation education support device of the present invention. The operation education support device of the present invention includes log collection means 71, determination means 72, video generation means 73, and delivery means 74.

The log collection means 71 (e.g., the log collection unit 5) collects logs generated in response to an operator's operations from a terminal where the operations are performed by the operator for task execution.

The determination means 72 (e.g., the determination unit 6) determines, for each collected log, whether the operator who was operating when the log was generated is an excellent operator or a non-excellent operator, using a first model for determining whether the operator who was operating when the log was generated is an excellent operator or a non-excellent operator.

The video generation means 73 (e.g., the video generation unit 10) generates an operation procedure video in response to the log of the operator determined as an excellent operator, using a second model for generating the operation procedure video in response to the log.

The delivery means 74 (e.g., delivery unit 12) delivers the operation procedure video to an education terminal used by an operator to learn an operation procedure for task execution.

Such a configuration enables efficient education of an operation procedure of a task.

The above example embodiment of the present invention and variations thereof may also be described as, but is not limited to, the following supplementary notes.

### (Supplementary Note 1)

An operation education support device comprising:
log collection means for collecting logs generated in response to an operator's operations from a terminal where the operations are performed by the operator for task execution;
determination means for determining, for each collected log, whether the operator who was operating when the log was generated is an excellent operator or a non-excellent operator, using a first model for determining whether the operator who was operating when the log was generated is an excellent operator or a non-excellent operator;
video generation means for generating an operation procedure video in response to the log of the operator determined as an excellent operator, using a second model for generating the operation procedure video in response to the log; and
delivery means for delivering the operation procedure video to an education terminal used by an operator to learn an operation procedure for task execution.

### (Supplementary Note 2)

The operation education support device according to supplementary note 1, wherein the first model is a model which is generated, by machine learning, using a set of pairs of a log generated in response to an operation determined to be excellent and a label of an excellent operator, and a set of pairs of a log generated in response to an operation determined to be non-excellent and a label of a non-excellent operator, as learning data for generating the first model.

### (Supplementary Note 3)

The operation education support device according to supplementary note 2 further comprising:
first learning means for generating the first model by machine learning.

### (Supplementary Note 4)

The operation education support device according to supplementary note 3,
wherein the determination means adds a pair of a log used for determination and a determination result as new data to the learning data for generating the first model, and
wherein the first learning means re-generates the first model by machine learning using the learning data for generating the first model to which the new data has been added.

### (Supplementary Note 5)

The operation education support device according to supplementary note 1,
wherein the second model is a model which is generated in advance, by machine learning, using a set of pairs of a log and an operation procedure video that represents an operation procedure when the log was generated, as learning data for generating the second model.

### (Supplementary Note 6)

The operation education support device according to supplementary note 5 further comprising:
second learning means for generating the second model by machine learning.

### (Supplementary Note 7)

The operation education support device according to any one of supplementary notes 1 to 6,
wherein the determination means selects, when there are multiple logs of an operator who is determined to be an excellent operator, a log with the shortest time from start of operation to end of operation from among the multiple logs,
wherein the video generation means generates the operation procedure video in response to the selected log.

### (Supplementary Note 8)

An operation education support system comprising:
an education terminal; and
the operation education support device according to supplementary note 1;
wherein the education terminal comprises:
display control means for displaying the operation procedure video delivered by the operation education support device on a display device.

### (Supplementary Note 9)

The operation education support system according to supplementary note 8,
wherein the display control means displays an image in accordance with an operation of an operator of the education terminal side-by-side with the operation procedure video on the display device.

### (Supplementary Note 10)

An operation education support method characterized in that,
a computer,
collects logs generated in response to an operator's operations from a terminal where the operations are performed by the operator for task execution;
determines, for each collected log, whether the operator who was operating when the log was generated is an excellent operator or a non-excellent operator, using a first model for determining whether the operator who was operating when the log was generated is an excellent operator or a non-excellent operator;
generates an operation procedure video in response to the log of the operator determined as an excellent operator, using a second model for generating the operation procedure video in response to the log; and
delivers the operation procedure video to an education terminal used by an operator to learn an operation procedure for task execution.

### (Supplementary Note 11)

An operation education support program causing a computer to execute:
a log collection process of collecting logs generated in response to an operator's operations from a terminal where the operations are performed by the operator for task execution;
a determination process of determining, for each collected log, whether the operator who was operating when the log was generated is an excellent operator or a non-excellent operator, using a first model for determining whether the operator who was operating when the log was generated is an excellent operator or a non-excellent operator;
a video generation process of generating an operation procedure video in response to the log of the operator determined as an excellent operator, using a second model for generating the operation procedure video in response to the log; and
a delivery process of delivering the operation procedure video to an education terminal used by an operator to learn an operation procedure for task execution.

While the present invention has been particularly shown and described with reference to example embodiment thereof, the present invention is not limited to this example embodiment. It will be understood by those of ordinary skill in the art that various changes in from and details may be made therein without departing from the spirit and scope of the present invention as defined by the claims.

This application is based upon and claims the benefit of priority from Japanese patent application No. 2023-020684, filed Feb. 14, 2023, the disclosure of which is incorporated herein in its entirety by reference.

### INDUSTRIAL APPLICABILITY

The present invention is suitably applied to an operation education support device and an operation education support system for having operators learn an operation procedure for task execution.

### REFERENCE SIGNS LIST

1 Operation education support device
2 First learning data storage unit
3 First learning unit
4 First model storage unit
5 Log collection unit
6 Determination unit
7 Second learning data storage unit
8 Second learning unit
9 Second model storage unit
10 Video generation unit
11 Video storage unit
12 Delivery unit
20 Terminal
30 Education terminal
100 Operation education support system

What is claimed is:

1. An operation education support device comprising:
a memory configured to store instructions; and
a processor configured to execute the instructions to:
collect logs generated in response to an operator's operations from a terminal where the operations are performed by the operator for task execution;
determine, for each collected log, whether the operator who was operating when the log was generated is an excellent operator or a non-excellent operator, using a first model for determining whether the operator who was operating when the log was generated is an excellent operator or a non-excellent operator;
generate an operation procedure video in response to the log of the operator determined as an excellent operator, using a second model for generating the operation procedure video in response to the log; and
deliver the operation procedure video to an education terminal used by an operator to learn an operation procedure for task execution.

2. The operation education support device according to claim 1,
wherein the first model is a model which is generated, by machine learning, using a set of pairs of a log generated in response to an operation determined to be excellent and a label of an excellent operator, and a set of pairs of a log generated in response to an operation determined to be non-excellent and a label of a non-excellent operator, as learning data for generating the first model.

3. The operation education support device according to claim 2,
wherein the processor generates the first model by machine learning.

4. The operation education support device according to claim 3,
wherein the processor adds a pair of a log used for determination and a determination result as new data to the learning data for generating the first model, and
wherein the processor re-generates the first model by machine learning using the learning data for generating the first model to which the new data has been added.

5. The operation education support device according to claim 1,
wherein the second model is a model which is generated in advance, by machine learning, using a set of pairs of a log and an operation procedure video that represents an operation procedure when the log was generated, as learning data for generating the second model.

6. The operation education support device according to claim 5,
wherein the processor generates the second model by machine learning.

7. The operation education support device according to claim 1,
wherein the processor selects, when there are multiple logs of an operator who is determined to be an excellent operator, a log with the shortest time from start of operation to end of operation from among the multiple logs,
wherein the processor generates the operation procedure video in response to the selected log.

8. An operation education support system comprising:
an education terminal; and
the operation education support device according to claim 1;
wherein the education terminal comprises:
a memory configured to store instructions; and
a processor configured to execute the instructions to:
display the operation procedure video delivered by the operation education support device on a display device.

9. The operation education support system according to claim 8,
wherein the processor displays an image in accordance with an operation of an operator of the education terminal side-by-side with the operation procedure video on the display device.

10. An operation education support method characterized in that,
a computer,
collects logs generated in response to an operator's operations from a terminal where the operations are performed by the operator for task execution;
determines, for each collected log, whether the operator who was operating when the log was generated is an excellent operator or a non-excellent operator, using a first model for determining whether the operator who was operating when the log was generated is an excellent operator or a non-excellent operator;
generates an operation procedure video in response to the log of the operator determined as an excellent operator, using a second model for generating the operation procedure video in response to the log; and
delivers the operation procedure video to an education terminal used by an operator to learn an operation procedure for task execution.

11. A non-transitory computer-readable recording medium in which an operation education support program is recorded, wherein the operation education support program causes a computer to execute:
a log collection process of collecting logs generated in response to an operator's operations from a terminal where the operations are performed by the operator for task execution;
a determination process of determining, for each collected log, whether the operator who was operating when the log was generated is an excellent operator or a non-excellent operator, using a first model for determining whether the operator who was operating when the log was generated is an excellent operator or a non-excellent operator;
a video generation process of generating an operation procedure video in response to the log of the operator determined as an excellent operator, using a second model for generating the operation procedure video in response to the log; and
a delivery process of delivering the operation procedure video to an education terminal used by an operator to learn an operation procedure for task execution.

12. The operation education support method according to claim 10,
wherein the first model is a model which is generated, by machine learning, using a set of pairs of a log generated in response to an operation determined to be excellent and a label of an excellent operator, and a set of pairs of a log generated in response to an operation determined to be non-excellent and a label of a non-excellent operator, as learning data for generating the first model.

13. The operation education support method according to claim 12,
wherein the computer generates the first model by machine learning,
wherein the computer adds a pair of a log used for determination and a determination result as new data to the learning data for generating the first model, and
wherein the computer re-generates the first model by machine learning using the learning data for generating the first model to which the new data has been added.

14. The operation education support method according to claim 10,
wherein the second model is a model which is generated in advance, by machine learning, using a set of pairs of a log and an operation procedure video that represents an operation procedure when the log was generated, as learning data for generating the second model.

15. The operation education support method according to claim 10,
wherein the computer selects, when there are multiple logs of an operator who is determined to be an excellent operator, a log with the shortest time from start of operation to end of operation from among the multiple logs,
wherein the computer generates the operation procedure video in response to the selected log.

16. The non-transitory computer-readable recording medium according to claim 11,
wherein the first model is a model which is generated, by machine learning, using a set of pairs of a log generated in response to an operation determined to be excellent and a label of an excellent operator, and a set of pairs of a log generated in response to an operation determined to be non-excellent and a label of a non-excellent operator, as learning data for generating the first model.

17. The non-transitory computer-readable recording medium according to claim 16,
wherein the operation education support program causes the computer generating the first model by machine learning,
wherein the operation education support program causes the computer, in the determination process, adding a pair of a log used for determination and a determination result as new data to the learning data for generating the first model, and
wherein the operation education support program causes the computer re-generating the first model by machine learning using the learning data for generating the first model to which the new data has been added.

18. The non-transitory computer-readable recording medium according to claim 11,
wherein the second model is a model which is generated in advance, by machine learning, using a set of pairs of a log and an operation procedure video that represents an operation procedure when the log was generated, as learning data for generating the second model.

19. The non-transitory computer-readable recording medium according to claim 11,
wherein the operation education support program causes the computer, in the determination process, selecting, when there are multiple logs of an operator who is determined to be an excellent operator, a log with the shortest time from start of operation to end of operation from among the multiple logs,
wherein the operation education support program causes the computer, in the video generation process, generating the operation procedure video in response to the selected log.
